(19) United States
(12) Patent Application Publication
(10) Pub. No.: US 2021/0299724 A1
(43) Pub. Date: Sep. 30, 2021

(54) COOLING APPARATUS

(71) Applicant: POSCO, Pohang-si, Gyeongsangbuk-do (KR)

(72) Inventors: Jong-Hoon Kang, Pohang-si, Gyeongsangbuk-do (KR); Gwan-Sik Min, Pohang-si, Gyeongsangbuk-do (KR); Hui-Seop KWON, Pohang-si, Gyeongsangbuk-do (KR)

(21) Appl. No.: 16/321,655

(22) PCT Filed: Apr. 4, 2017
(86) PCT No.: PCT/KR2017/003695

§ 371 Date: Jan. 29, 2019

(30) Foreign Application Priority Data
Aug. 5, 2016 (KR) 10-2016-0100001

(51) Int. Cl. B21B 45/02; C21D 1/667; C21D 9/46; C21D 1/60

(52) U.S. Cl. CPC B21B 45/0233; C21D 1/60; C21D 9/46; C21D 1/667

(57) ABSTRACT

A cooling apparatus according to an embodiment of the present invention may comprise: a chamber member to which a cooling fluid is supplied from the outside; a discharge member, provided in the chamber member, for discharging the cooling fluid inside the chamber unit; and a resistance member, provided in an inlet portion of the chamber member, for inhibiting an initial flow of the cooling fluid supplied into the chamber member.

### TECHNICAL FIELD

The present disclosure relates to a cooling apparatus performing cooling for a body, such as a hot-rolled steel sheet, or the like, to be cooled.

### BACKGROUND ART

A steel sheet passing through a rolling mill is cooled on a run out table. Cooling is mainly performed by using cooling water and using a method of spraying the cooling water through a nozzle.

Among cooling methods, coolers spraying the cooling water through the nozzle may be divided into a turbulent cooler, a spray cooler, and a laminar cooler, depending on types of spraying of the cooling water.

A turbulent cooler sprays cooling water onto the steel sheet by applying a large amount of pressure to an interior. Therefore, the turbulent cooler has a disadvantage in that it may make the entire installation complicated and requires high installation costs, since a supplementary apparatus forming pressure is required.

In addition, since the speed of the cooling water sprayed through the nozzle is very fast, the flow of cooling the steel sheet may be very unstable. Therefore, when a hot-rolled steel sheet is cooled using a turbulent cooler, a large temperature deviation in a width direction of the hot-rolled steel sheet occurs.

On the other hand, a spray cooler is an apparatus spraying cooling water through a nozzle having a very small diameter, and may spray the cooling water relatively uniformly over an entire area of the steel sheet.

However, the spray cooler has a very small amount of cooling water discharged per unit time, such that the hot-rolled steel sheet may not be cooled rapidly, and the cooling efficiency may be also lowered.

Contrary to the aforementioned two apparatuses, the laminar cooler is an apparatus which solves the problems mentioned to some extent and may relatively stably supply cooling water to uniformly cool the steel sheet in the width direction.

Such a conventional laminar cooler is illustrated in FIG. 1. As illustrated in FIG. 1, the conventional laminar cooler 1′ mainly includes a chamber member 100′ in which cooling water is stored and a discharge member 200′ guiding a flow of the cooling water supplied to a surface of the steel sheet. In this case, a plurality of discharge members 200′ are formed in the chamber member 100′ in a width direction of the steel sheet.

A supply pipe 2′ supplying cooling water into the chamber member 100′ is coupled to and provided in one end portion of the chamber member 100′.

Here, when cooling water is supplied to the chamber member 100′ through the supply pipe 2′, the cooling water is not completely filled inside the chamber member 100′, such that the supplied cooling water may freely form a flow shape in the chamber member 100′.

However, the cooling water flowing into one end portion of the chamber member 100′ through the supply pipe 2′ has a strong momentum of flow, such that the cooling water starts to be supplied onto a steel sheet through the discharge member 200′ in a state in which the cooling water is distributed to the other end portion of the chamber member 100′ in a biased manner.

That is, a problem of supplying water in a biased manner, in which cooling water is not discharged from the discharge member 200′ coupled to one end portion side of the chamber member 100′ and cooling water is only discharged from the discharge member 200′ coupled to the other end portion side of the chamber member 100′may occur.

Accordingly, it may cause a serious problem of deterioration of the quality of the steel sheet due to unbalanced cooling of the steel sheet.

Therefore, there is a need to study a cooling apparatus for solving the aforementioned problems.

### DISCLOSURE

### Technical Problem

An aspect of the present disclosure is to provide a cooling apparatus for preventing cooling fluid from being discharged in a biased manner to prevent deterioration of cooling quality due to unbalanced cooling for a body such as a steel sheet, or the like, to be cooled.

### Technical Solution

According to an aspect of the present disclosure, a cooling apparatus may include: a chamber member to which a cooling fluid is supplied from an outside; a discharge member provided in the chamber member and discharging the cooling fluid inside the chamber unit; and a resistance member provided in an inlet portion of the chamber member from which the cooling fluid is supplied to the chamber member and inhibiting an initial flow of the cooling fluid supplied to the chamber member.

In addition, the resistance member, according to an exemplary embodiment in the present disclosure, may include an internal resistance chamber portion provided in the inlet portion and surrounding the cooling fluid.

In addition, the resistance member of the cooling apparatus according to an exemplary embodiment in the present disclosure may include a porous plate portion coupled to the internal resistance chamber portion and formed of a porous plate member, to prevent the flow of the cooling fluid discharged from an internal chamber discharge hole formed in the internal resistance chamber portion.

In addition, the porous plate portion of the cooling apparatus according to an exemplary embodiment in the present disclosure may include a vertical porous plate vertically coupled to a wall portion of the internal resistance chamber portion and a horizontal porous plate coupled to the vertical porous plate and provided horizontally with respect to the wall portion of the internal resistance chamber portion.

In addition, the internal resistance chamber portion of the cooling apparatus according to an exemplary embodiment in the present disclosure may be provided with a width larger than a width of a supply pipe coupled to an outer wall of the inlet portion of the chamber member, to supply the cooling fluid to the chamber member.

In addition, the internal resistance chamber portion of the cooling apparatus according to an exemplary embodiment in the present disclosure may include an internal chamber box provided in the inlet portion and surrounding the cooling fluid supplied to the inlet portion and an internal partition wall provided inside the internal chamber box and partially blocking the a flow path of the cooling fluid.

In addition, the internal chamber box of the cooling apparatus according to an exemplary embodiment in the present disclosure may have one end portion coupled to the inlet portion, which is one end portion of the chamber member and the other end portion extending in a longitudinal direction of the chamber member to be coupled to the other end portion of the chamber member.

In addition, the internal partition wall of the cooling apparatus according to an exemplary embodiment in the present disclosure is provided above an internal chamber discharge hole formed in the internal chamber box and discharging the cooling fluid, is provided as a plurality of internal partition walls in a longitudinal direction of the chamber member, and an interval between adjacent internal partition walls is provided to be wider from one end portion of the internal chamber box to the other end portion.

In addition, a plurality of internal partition walls of the cooling apparatus according to an exemplary embodiment in the present disclosure are provided in the longitudinal direction of the chamber member, and an area blocking the cooling fluid decreases from one end portion of the internal chamber box to the other end portion.

In addition, the internal resistance chamber portion of the cooling apparatus according to an exemplary embodiment in the present disclosure may include an internal chamber discharge hole from which the cooling fluid is discharged and in which a smaller diameter is formed from an inlet portion, which is one end portion of the chamber member to the other end portion of the chamber member.

In addition, the internal partition wall of the cooling apparatus according to an exemplary embodiment in the present disclosure may include a primary partition wall provided inside the internal chamber box, disposed horizontally in the width direction of the chamber member and a secondary partition wall provided in the primary partition wall and provided horizontally in the longitudinal direction of the chamber member.

### Advantageous Effects

The cooling apparatus in the present disclosure has an advantage of reducing an initial flow of a cooling fluid flowing into a chamber member.

As a result, it is possible to prevent the cooling fluid from being distributed in a biased manner and to prevent the cooling fluid discharged through a discharge member from being discharged in a biased manner.

Therefore, a body to be cooled such as a steel sheet, or the like, cooled by the cooling fluid discharged through the discharge member may be uniformly cooled, such that the cooling quality may be improved.

### DESCRIPTION OF DRAWINGS

FIG. 1 is a side view illustrating a conventional cooling apparatus.

FIG. 2 is a front view illustrating a cooling apparatus of the present disclosure.

FIG. 3 is a plan view illustrating a resistance member in a cooling apparatus of the present disclosure.

FIG. 4 is a side view illustrating a resistance member in a cooling apparatus of the present disclosure.

FIG. 5 is a perspective view illustrating a resistance member in a cooling apparatus of the present disclosure.

FIG. 6 is a side view illustrating an exemplary embodiment in which a resistance area of an internal partition wall is differently configured according to positions in a cooling apparatus of the present disclosure.

FIG. 7 is a side view illustrating an exemplary embodiment in which the number of internal partition walls is differently configured according to a position of an internal partition wall in a cooling apparatus of the present disclosure.

FIG. 8 is a side view and a plan view illustrating an exemplary embodiment in which an internal partition wall includes a primary partition wall and a secondary partition wall in a cooling apparatus of the present disclosure.

FIG. 9 is a graph illustrating a comparison between results of supplying water of a cooling apparatus of the present disclosure and an existing cooling apparatus.

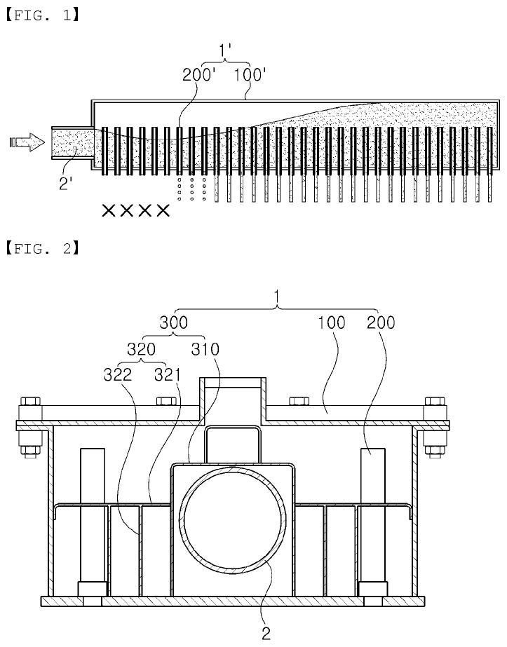

### BEST MODE FOR INVENTION

Hereinafter, specific embodiments of the present disclosure will be described in detail with reference to the accompanying drawings. It will be apparent to those skilled in the art that modifications and variations could be made without departing from the scope of the present disclosure, as defined by the appended claims.

In addition, the same reference numerals will be used throughout the drawings for elements having the same or similar functions and operations.

The present disclosure relates to a cooling apparatus 1 performing cooling for a body to be cooled such as a hot-rolled steel sheet, and the like, which may reduce an initial flow of a cooling fluid flowing into a chamber member 100. As a result, the cooling fluid inside the chamber member 100 may be prevented from being distributed in a biased manner, such that the cooling fluid discharged through a discharge member 200 may be prevented from being discharged in a biased manner.

Therefore, a body to be cooled such as a steel sheet, or the like, cooled by the cooling fluid discharged through the discharge member 200 may be uniformly cooled, such that the cooling quality may be improved.

Here, the cooling apparatus 1 of the present disclosure has a configuration close to that of a laminar cooler, among a turbulent cooler, a spray cooler, and a laminar cooler according to cooling water spraying type.

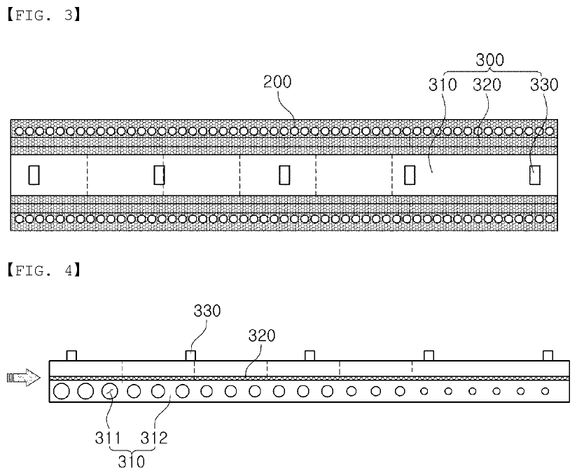

Specifically, FIG. 2 is a front view illustrating a cooling apparatus 1 of the present disclosure, and FIG. 9 is a graph illustrating a comparison between results of supplying water of the cooling apparatus 1 of the present disclosure and an existing cooling apparatus 1′. Referring to FIG. 2, the cooling apparatus 1 according to an exemplary embodiment in the present disclosure may include a chamber member 100 to which a cooling fluid is supplied from an outside, a discharge member 200 provided in the chamber member 100 and discharging the cooling fluid inside the chamber unit, and a resistance member 300 provided in an inlet portion of the chamber member from which the cooling fluid is supplied to the chamber member 100 and inhibiting an initial flow of the cooling fluid supplied to the chamber member 100.

As described above, uniform cooling of a body, such as a hot-rolled steel sheet, or the like, to be cooled, in a width direction may be performed by inhibiting the initial flow of the cooling fluid to which the resistance member 300 is supplied, and by discharging the cooling fluid supplied to the chamber member 100 through the discharge member 200 while uniformly distributing the cooling fluid throughout the chamber member 100.

This may be confirmed in FIG. 9. That is, a flow rate of a cooling fluid supplied through a supply pipe 2 is changed to 100%, 50%, and 30%. In addition, it is measured whether or not the cooling water is uniformly supplied in the cooling apparatus 1 of the present disclosure, and whether or not the cooling water is uniformly supplied in the existing cooling apparatus 1′, which does not include the resistance member 300.

Thus, it can be seen that the cooling apparatus 1 of the present disclosure performs uniform spraying water from an inlet portion, which is one end portion of the chamber member 100 in which the supply pipe is coupled. However, it can be seen that the existing cooling apparatus 1′ does not perform spraying water into one end portion of the chamber member 100′.

That is, the cooling apparatus 1 of the present disclosure may perform uniform supplying water as compared with the existing cooling apparatus 1′.

The chamber member 100 may serve as a body of an apparatus provided with the discharge member 200 and the resistance member 300, and may be provided with a cooling fluid from the outside and to be supplied through the discharge member 200.

Thus, the chamber member 100 has a space in which the cooling fluid may be stored therein. To supply the cooling fluid from the outside, the supply pipe 2 may be coupled to an outer wall and provided.

The chamber member 100 may includes a container-shaped lower frame and an upper frame coupled to an upper portion of the lower frame to form a space in which a cooling fluid is stored therein. The lower frame and the upper frame may be coupled by bolting.

The discharge member 200 serves to discharge the cooling fluid provided inside the chamber member 100 to the body, such as a hot-rolled steel sheet, or the like, to be cooled.

For this, the discharge member 200 may be provided inside the chamber member 100, and a lower end portion thereof may be provided to penetrate a lower surface of the chamber member 100 and an upper end portion thereof may be provided extending in a height direction of the chamber member 100.

In addition, a plurality of discharge members 200 may be provided at uniform intervals in a longitudinal direction of the chamber member 100, to uniformly supply water in the width direction of the body to be cooled.

The resistance member 300 serves to a resistor of the cooling fluid supplied to the chamber member 100. In other words, the resistance member 300 may be provided to prevent the cooling fluid from being unevenly distributed inside the chamber member 100, as the initial supply flow momentum of the cooling fluid supplied to the chamber member 100 is strongly formed.

As described above, the resistance member 300 may be provided as a resistor inhibiting the initial flow of the cooling fluid, and may uniformly distribute the cooling fluid inside the chamber member 100. For this, the resistance member 300 may include an internal resistance chamber portion 310, a porous plate portion 320, and the like.

Here, the internal resistance chamber portion 310 serves to primarily inhibit the flow of the cooling fluid flowing into the chamber member 100.

That is, the resistance member 300 of the cooling apparatus 1 according to an exemplary embodiment in the present disclosure may include the internal resistance chamber portion 310 provided in the inlet portion to surround the cooling fluid.

In other words, the internal resistance chamber portion 310 serves to uniformly distribute the cooling fluid into the chamber member 100, before the cooling fluid supplied to the chamber member 100 is discharged through the discharge member 200 at an initial stage of the inflow of the cooling fluid.

For this, the internal resistance chamber portion 310 is provided in a shape of surrounding the inlet portion, which is one end portion of the chamber member 100 which the cooling fluid is supplied to the chamber member 100.

Further, the internal resistance chamber portion 310 may be provided having a width greater than a width of the supply pipe 2 to which the cooling fluid is supplied, to completely surround the cooling fluid supplied to the inlet portion.

That is, the internal resistance chamber portion 310 of the cooling apparatus 1 according to an exemplary embodiment in the present disclosure may be provided in the inlet portion to have a width larger than the width of the supply pipe 2 coupled to the outer wall of the inlet portion of the chamber member 100 to supply the cooling fluid to the chamber member 100.

In other words, by providing the internal resistance chamber portion 310 to surround the through hole of the supply pipe 2 coupled to the chamber member 100, the internal resistance chamber portion 310 may serve to inhibit the initial flow of the cooling fluid supplied to the chamber member 100 through the supply pipe 2.

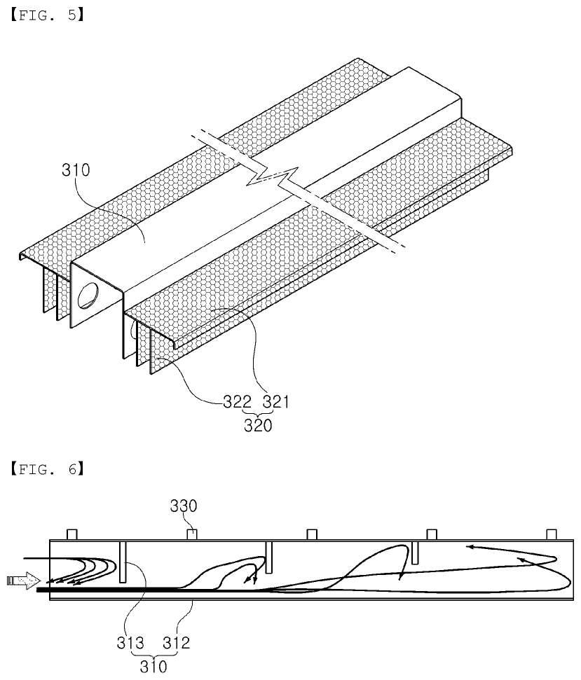

On the other hand, the internal resistance chamber portion 301 may provide an internal chamber discharge hole for discharging the cooling fluid surrounded at the initial stage of the inflow from the inside of the internal resistance chamber portion 310 to the outside, after the flow of the cooling fluid is primarily reduced, which will be described later in detail with reference to FIG. 4.

The internal resistance chamber portion 310 may include a configuration of an internal chamber box 312, an internal partition wall 313, and the like, as a configuration for inhibiting the flow of the cooling fluid, which will be described later in detail with reference to FIGS. 6, 7 and 8.

On the other hand, the resistance member 300 may configure the internal resistance chamber portion 310 to correspond to a height of the chamber member 100, to stably couple to the internal resistance chamber portion 310 inside the chamber member 100.

However, to reduce a flow range of the cooling fluid, the internal resistance chamber portion 310 may be provided to be smaller than the height of the chamber member 100. In this case, to stably couple to the internal resistance chamber portion 310 to the chamber member 100, a support unit 30 may be further provided between an outer surface of an upper side wall portion of the internal resistance chamber portion 310 and an inner surface of an upper side wall portion of the chamber member 100.

The porous plate portion 320 may serve to secondarily reduce the flow of the cooling fluid, which is primarily reduced in the internal resistance chamber portion 310. The description of the porous plate portion 320 will be described later in detail with reference to FIG. 3.

FIG. 3 is a plan view illustrating a resistance member 300 in a cooling apparatus 1 according to an exemplary embodiment in the present disclosure. Referring to FIG. 3, the resistance member 300 of the cooling apparatus 1 according to an exemplary embodiment in the present disclosure may include a porous plate portion 320 coupled to the internal resistance chamber portion 310 and formed of a porous plate member, to inhibit the flow of the cooling fluid discharged from an internal chamber discharge hole 311 formed in the internal resistance chamber portion 310.

That is, the porous plate portion 320 is configured to secondarily reduce the flow of the cooling fluid which is primarily reduced in the internal resistance chamber portion 310.

In particular, the porous plate portion 320 may be provided with a porous plate such that the porous plate portion 320 is configured to also reduce relatively small flow momentum. Here, it is required that an opening ratio of the porous plate portion 320 be provided at about 20 to 70% to perform a role as a secondary resistor.

In other words, the opening ratio of the porous plate portion 320 as described above is illustrated because when the opening ratio is less than about 20%, the cooling fluid may be accumulated in the porous plate portion 320 and may not be discharged from the porous plate portion 320 at a higher speed than the speed of spraying water for performing cooling, which is not required, and when the opening ratio exceeds about 70%, an effect of reducing the flow momentum is negligible, which is not required.

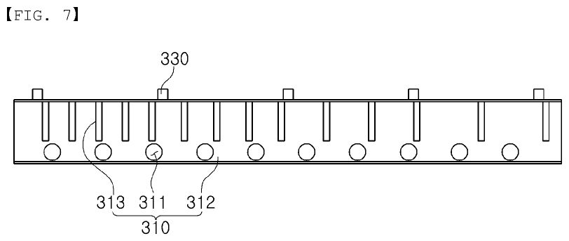

The porous plate portion 320 may include a vertical porous plate 321 and a horizontal porous plate 322, to efficiently perform reducing the flow momentum of the cooling fluid. The detailed description thereof will be described later with reference to FIG. 5.

FIG. 4 is a side view illustrating a resistance member 300 in a cooling apparatus 1 of the present disclosure. Referring to FIG. 4, the internal resistance chamber portion 301 of the cooling apparatus 1 according to an exemplary embodiment in the present disclosure may include an internal chamber discharge hole 311 from which the cooling fluid is discharged and in which a smaller diameter is formed from an inlet portion, which is one end portion of the chamber member 100 to the other end portion of the chamber member 100.

That is, the internal resistance chamber portion 310 induces to perform supplying water through the discharge member 200 after primarily reducing the flow of the cooling fluid. For this, the internal resistance chamber portion 310 is configured to include an internal chamber discharge hole 311 for discharging the cooling fluid surrounded at the initial stage of the inflow from the inside of the internal resistance chamber portion 310, and the internal resistance chamber portion 310 is configured to uniformly discharge the cooling fluid discharged from the inside of the internal resistance chamber portion 310 to the outside in the longitudinal direction of the chamber member 100 by differently forming a width of the internal chamber discharge hole 311 in the longitudinal direction of the chamber member 100.

In other words, by the initial flow momentum in which the cooling fluid is supplied to the chamber member 100, a relatively large amount of the cooling fluid is biased and distributed in the other end portion of the internal resistance chamber portion 310 (which is located in the same position as that of the other end portion of the chamber member 100) than one end portion of the internal resistance chamber portion 310 adjacent to the supply pipe 2 (which is located in the same position as one end portion of the chamber member 100), such that the diameter of the internal chamber discharge hole 311 provided in one end portion of the internal resistance chamber portion 310 may be formed to be larger than that of the internal chamber discharge hole 311 provided in the other end portion of the internal resistance chamber portion 310 to uniformly discharge the cooling fluid in the longitudinal direction of the chamber member 100.

FIG. 5 is a perspective view illustrating a resistance member 300 in a cooling apparatus 1 of the present disclosure. Referring to FIG. 5, the porous plate portion 320 of the cooling apparatus 1 according to an exemplary embodiment in the present disclosure may include a vertical porous plate 321 vertically coupled to a wall portion of the internal resistance chamber portion 310 and a horizontal porous plate 322 coupled to the vertical porous plate 321 and horizontally provided to the wall portion of the internal resistance chamber portion 310.

That is, the porous plate portion 320 may include the vertical porous plate 321 and the horizontal porous plate 322, to efficiently perform the flow momentum reduction of the cooling fluid.

In other words, the vertical porous plate 321 may be vertically coupled to the wall portion of the internal resistance chamber portion and extend to the inner surface of the chamber member 100 and be provided. The vertical porous plate 321 serves as an obstacle for secondarily blocking the flow of the cooling fluid before the cooling fluid discharged from the internal resistance chamber portion moves to the discharge member 200.

In this case, by further providing the horizontal porous plate 322, the flow of the cooling fluid discharged from the internal resistance chamber portion 310 may be inhibited once more together with the vertical porous plate 321, thereby effectively performing the flow momentum reduction.

FIG. 6 is a side view illustrating an exemplary embodiment in which a resistance area of the internal partition wall 313 is differently configured according to positions in the cooling apparatus 1 of the present disclosure. Referring to FIG. 6, the internal resistance chamber portion 310 of the cooling apparatus 1 according to an exemplary embodiment in the present disclosure may include an internal chamber box 312 provided in the inlet portion and surrounding the cooling fluid supplied to the inlet portion and an internal partition wall 313 provided inside the internal chamber box 312 and partially blocking the flow path of the cooling fluid.

That is, the internal resistance chamber portion 310 may include the internal chamber box 312 and the internal partition wall 313 as a configuration for inhibiting the flow of the cooling fluid.

The internal chamber box 312 may primarily surround the cooling fluid supplied into the inlet portion of the chamber member 100. In other words, the initial flow of the cooling fluid supplied to the chamber member 100 may be blocked inside the internal chamber box 312, such that the problem in which the cooling fluid is provided in a biased manner inside the chamber member 100 may be prevented.

For this, the internal chamber box 312 may be provided in a box shape surrounding a hole penetrating the supply pipe 2 provided in an outer wall of the chamber member 100, one end portion thereof may be coupled to one end portion, which is an inlet portion of the chamber member 100 and the other end portion thereof may be coupled to the other end portion of the chamber member 100.

In other words, the internal chamber box 312 of the cooling apparatus 1 according to an exemplary embodiment in the present disclosure may have one end portion coupled to the inlet portion, which is one end portion of the chamber member 100 and the other end portion extending in a longitudinal direction of the chamber member 100 to be coupled to the other end portion of the chamber member 100.

The internal partition wall 313 serves to reduce the flow of the cooling fluid surrounded and flowed inside the internal chamber box 312. For this, the internal partition wall 313 is provided inside the internal chamber box 312 and provided to partially block the flow path of the cooling fluid.

For example, the plurality of internal partition walls 313 are provided inside the internal chamber box 312, the internal partition wall provided adjacent to one end portion of the internal chamber box 312 is provided to form a larger resistance area on the flow path of the cooling fluid than the internal partition wall 313 provided adjacent to the other end portion of the internal chamber box 312.

That is, the plurality of internal partition walls 313 of the cooling apparatus 1 according to an exemplary embodiment in the present disclosure are provided in the longitudinal direction of the chamber member 100, and are provided such that an area blocking the cooling fluid from one end portion of the internal chamber box 312 to the other end portion is reduced.

The internal partition wall 313 has a shape in which the plurality of internal partition walls 313 are provided to couple to the upper surface of the internal chamber box 312, and a formation height thereof may be reduced from one end portion of the internal chamber box 312 to the end portion, which may be a form illustrated in FIG. 6.

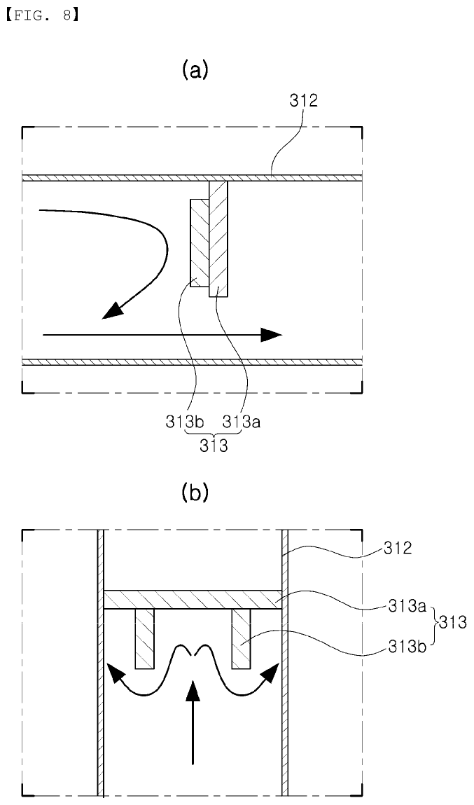

In addition, a plurality of internal partition walls 313 are provided with a plurality of identical resistance areas on the flow path of the cooling fluid and are provided to efficiently perform the flow momentum reduction by specifying the provided intervals, which will be described later in detail with reference to FIG. 7.

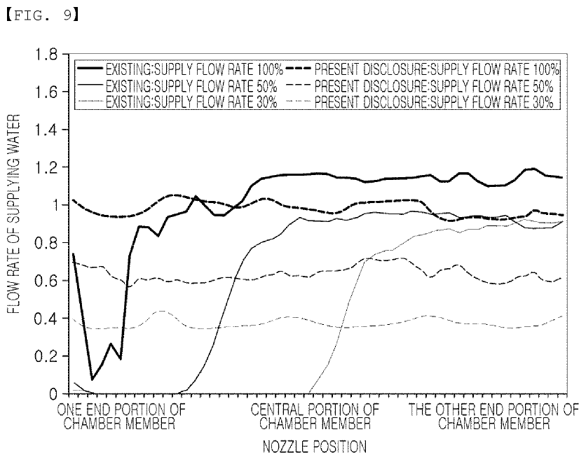

The plurality of internal partition walls 313 are provided with a plurality of identical resistance areas on the flow path of the cooling fluid and are provided to efficiently perform the flow momentum reduction by providing the provided shape in a specific shape, which will be described later in detail with reference to FIG. 8.

FIG. 7 is a side view illustrating an exemplary embodiment in which the number thereof is differently configured according to positions of the internal partition wall 313 in the cooling apparatus 1 of the present disclosure. Referring to FIG. 7, the internal partition wall 313 of the cooling apparatus 1 according to an exemplary embodiment in the present disclosure is formed in the internal chamber box 312 and is provided above an internal chamber discharge hole 311 discharging the cooling fluid. The plurality of internal partition walls 313 are provided in the longitudinal direction of the chamber member 100. An interval between adjacent internal partition walls 313 is provided to be wider from one end portion the internal chamber box 312 to the other end portion.

That is, the plurality of internal partition walls 313 are provided with a plurality of the same resistance areas on the flow path of the cooling fluid and is provided to efficiently perform the flow momentum reduction by specifying the provided intervals.

In other words, by providing more internal partition walls 313 on one end portion of the internal chamber box 312 provided with a relatively large flow momentum than the other end portion of the internal chamber box 312 provided with a relatively small flow momentum, a dispositional internal of the internal partition wall 313 is adjusted such that more flow momentums are reduced.

FIG. 8 is a side view and a plan view illustrating an exemplary embodiment in which an internal partition wall 313 includes a primary partition wall 313a and a secondary partition wall 313b in the cooling apparatus of the present disclosure. Referring to FIG. 8, the internal partition wall 313 of the cooling apparatus 1 according to an exemplary embodiment may include the primary partition wall 313a provided inside the internal chamber box 312 horizontally in the width direction of the chamber member 100 and the secondary partition wall 313b provided in the primary partition wall 313a and horizontally provided in the longitudinal direction of the chamber member 100.

In other words, the internal partition wall 313 is provided with a plurality of the same resistance areas on the flow path of the cooling fluid and is provided to efficiently perform flow momentum reduction by providing the provided shape in a specific shape.

As such, since the primary partition wall 313a is horizontally provided in the width direction of the chamber member 100, and the secondary partition wall 313b is horizontally provided, the shape formed by the primary partition wall 313a and the secondary partition wall 313b is provided in “⊏” shape, and is provided to surround the flow of the cooling fluid.

That is, as the flow of the cooling fluid is surrounded by the primary partition wall 313a and the secondary partition wall 313b, the cooling fluid may consume the flow momentum to escape to the other path, thereby improving the efficiency of the flow momentum reduction of the cooling fluid.

1. A cooling apparatus comprising:
a chamber member to which a cooling fluid is supplied from an outside;
a discharge member provided in the chamber member, and discharging the cooling fluid inside the chamber unit; and
a resistance member provided in an inlet portion of the chamber member from which the cooling fluid is supplied and inhibiting an initial flow of the cooling fluid supplied to the chamber member.

2. The cooling apparatus of claim 1, wherein the resistance member comprises an internal resistance chamber portion provided in the inlet portion to surround the cooling fluid.

3. The cooling apparatus of claim 2, wherein the resistance member comprises a porous plate portion coupled to the internal resistance chamber portion, to inhibit the flow of the cooling fluid discharged from an internal chamber discharge hole formed in the internal resistance chamber portion and formed of a porous plate member.

4. The cooling apparatus of claim 3, wherein the porous plate portion comprises a vertical porous plate vertically coupled to a wall portion of the internal resistance chamber portion; and a horizontal porous plate coupled to the vertical porous plate and provided horizontally with respect to the wall portion of the internal resistance chamber portion.

5. The cooling apparatus of claim 2, wherein the internal resistance chamber portion is provided in the inlet portion to have a width larger than a width off a supply pipe coupled to an outer wall of the inlet portion of the chamber member to supply the cooling fluid to the chamber member.

6. The cooling apparatus of claim 2, wherein the internal resistance chamber portion comprises an internal chamber box provided in the inlet portion and surrounding the cooling fluid supplied to the inlet portion; and an internal partition wall provided inside the internal chamber box and partially blocking the flow path of the cooling fluid.

7. The cooling apparatus of claim 6, wherein the internal chamber box has one end portion coupled to an inlet portion, which is one end portion of the chamber member, and the other end portion extending in the longitudinal direction of the chamber member and coupled to the other end portion of the chamber member.

8. The cooling apparatus of claim 7, wherein the internal partition wall is provided above an internal chamber discharge hole formed in the internal chamber box and discharging the cooling fluid, is provided as a plurality of internal partition walls in the longitudinal direction of the chamber member, and an interval between adjacent internal partition walls is provided to be wider from one end portion of the internal chamber box to the other end portion.

9. The cooling apparatus of claim 7, wherein the plurality of internal partition walls are provided in the longitudinal direction of the chamber member and an area blocking the cooling fluid decreases from one end portion of the internal chamber box to the other end portion.

10. The cooling apparatus of claim 7, wherein the internal resistance chamber portion comprises an internal chamber discharge hole from which the cooling fluid is discharged and in which a smaller diameter is formed from an inlet portion, which is one end portion of the chamber member to the other end portion of the chamber member.

11. The cooling apparatus of claim 6, wherein the internal partition wall comprises a primary partition wall provided inside the internal chamber box, disposed horizontally in a width direction of the chamber member; and
a secondary partition wall provided in the primary partition wall and horizontally provided in the longitudinal direction of the chamber member.
